(19) United States
(12) Patent Application Publication
(10) Pub. No.: US 2017/0143159 A1
(43) Pub. Date: May 25, 2017

(54) KITCHEN APPLIANCE

(71) Applicant: Vorwerk & Co. Interholding GmbH, Wuppertal (DE)

(72) Inventors: Thomas BRAUN, Wuppertal (DE); Frank STARFLINGER, Bochum (DE)

(73) Assignee: Vorwerk & Co. Interholding GmbH, Wuppertal (DE)

(21) Appl. No.: 15/318,457

(22) PCT Filed: Jun. 24, 2015
(86) PCT No.: PCT/EP2015/064225

§ 371 Date: Dec. 13, 2016

(30) Foreign Application Priority Data
Jun. 25, 2014 (DE) 10 2014 108 928.6

(51) Int. Cl. A47J 36/10; A47J 43/07; A47J 27/08

(52) U.S. Cl. CPC A47J 36/10; A47J 27/0804; A47J 43/07; H02J 7/345

(57) ABSTRACT

A kitchen appliance, comprising a vessel and a cover for closing an opening in the vessel, wherein a locking mechanism, with which the cover can be locked to the vessel, and a control device, with which the locking state of the locking mechanism can be controlled, are provided. A proximity sensor is provided, it being possible to use the proximity sensor to detect the physical approach by a hand of a user below a predetermined distance from the proximity sensor, and the proximity sensor is connected to the control-device in such a way that an approach by the hand of the user to the proximity sensor below the predetermined distance can be detected by the control device and the locking mechanism can then be driven by the control device in such a way that the locking mechanism unlocks the cover. Therefore, a kitchen appliance of this kind comprising a vessel and a cover for closing an opening in the vessel is specified, with simple unlocking of the cover being made possible for the kitchen appliance.

The invention relates to a kitchen appliance, with a vessel and cover for closing an opening of the vessel, wherein a locking mechanism with which the cover can be locked to the vessel and a control device with which the locking state of the locking mechanism can be controlled are provided.

Such kitchen appliances, which exhibit a vessel and cover for closing the vessel, are well known in practice. Let reference be made to pressure cookers and multifunctional food processors as examples. The latter are as a rule provided with a kind of vessel that is able to hold foods, so that they can be processed therein. This processing of foods can involve comminuting, mixing or kneading, for example. Also known are vessels of food processors that offer additional functions, such as weighing the foods contained therein and/or heating.

It is often desired that the cover for closing the vessel can be fixedly locked with the vessel by means of a locking mechanism, so as to prevent food contained in the vessel from inadvertently exiting while being processed. The cover can here be locked in various ways, for example by pressing a button or moving the cover into a locked position, e.g., by placing the cover on the opening of the vessel and then twisting it by a predetermined angle. Unlocking can involve a similar process: In other words, the cover can be unlocked by pressing a button or, for example, also by manually turning the cover from the locked position back into an unlocked position.

The object of the invention is to indicate such a kitchen appliance with a vessel and cover for closing an opening of the vessel that makes it easy to unlock the cover.

This object is achieved by the subject matter of claim 1. Preferred further developments may be gleaned from the subclaims.

As a consequence, the invention furnishes a kitchen appliance with a vessel and cover for closing the opening of the vessel, wherein a locking mechanism, with which the cover can be locked with the vessel, and a control device, with which the locking state of the locking mechanism can be controlled, are provided, characterized in that a proximity sensor is provided, which can be used to detect a physical approach by the hand of a user below a predetermined distance from the proximity sensor, and the proximity sensor is connected with the control device in such a way that the control device can detect an approach by the hand of the user to a proximity sensor below the predetermined distance, after which it can actuate the locking mechanism in such a way that the latter unlocks the cover.

Therefore, an essential point of the invention is that the user of the kitchen appliance need only bring his or her hand into a predetermined position in order to lock the cover, without having to here actively actuate any device of the kitchen appliance. The user thus does not have to press a button or touch and move the cover to get from the locked state to the unlocked state. Rather, it is possible to arrange the proximity sensor in or on the kitchen appliance in such a way that the cover is locked as the result of a natural movement by the hand of the user in advance of opening or removing the latter.

In this conjunction, a preferred further development of the invention provides that the vessel exhibit a handle, and the proximity sensor be situated in the handle. As a result, the cover can be automatically unlocked when the user touches the handle of the vessel, which can be a typical handle, in advance of removing the cover from the vessel. The process often happens to involve the user holding the handle of the vessel with his or her hand, so as to grab the cover with the other hand and remove it from the vessel.

As explained above, the invention does not absolutely require that a device of the kitchen appliance be actuated or even touched by the hand. However, in the preferred exemplary embodiment of the invention described here, in which the user grabs the handle of the vessel with his or her hand, direct contact takes between the handle and hand. In this regard, a preferred further development of the invention provides that the proximity sensor be situated inside of the handle spaced a distance apart from the surface of the handle, with the distance being less than the predetermined distance. This always ensures that the cover is unlocked when the handle is touched. In order to prevent inadvertent unlocking, it can also be provided in this conjunction that the cover only be unlocked from the vessel if the hand is uninterruptedly located within the predetermined distance from the proximity sensor for a predetermined period of time.

A preferred further development of the invention additionally or alternatively provides that the proximity sensor be situated in the cover. Accordingly, it is here also preferred that the proximity switch be located inside of the cover spaced a distance apart from the surface of the cover, with the distance being less than the predetermined distance. In any event, placing at least one hand on the cover, e.g., in order to then remove the cover from the vessel, thus causes the cover to be unlocked. It can also be provided that unlocking actually take place only after a predetermined period of time, so as to prevent an inadvertent unlocking by simply waving by the hand.

The proximity sensor and the control device used to actuate the locking mechanism can be hardwired to each other. However, a preferred further development of the invention provides for wireless signal transmission between the proximity sensor and control device. In this way, the control device can be provided in a part of the kitchen appliance other than the cover or vessel, without here having to provide a wired connection that has to be disengaged during removal of the cover from the vessel or the vessel from the remaining kitchen appliance and reestablished during replacement. Expensive and error-prone plug contacts or similar devices can be avoided in this way.

The proximity sensor can derive the energy for operation from the remaining part of the kitchen appliance, for example, in particular given an electrical kitchen appliance connected with the household power supply system, or from a battery. However, a preferred further development of the invention provides that the proximity sensor exhibit a power supply in which energy is generated based on the principle of energy harvesting. The term “energy harvesting” refers to the generation of electrical energy using sources available in the environment, such as ambient temperature, ambient light or an electromagnetic field. The amount of energy that can be generated in this way is typically relative low, but thus often sufficient for purposes of a short-term measurement and/or wireless signal transmission of an acquired signal.

Energy generated based on the principle of energy harvesting can be fed directly to the proximity sensor to supply it with energy. However, a preferred further development of the invention provides an intermediate energy store, which can be used to intermediately store energy generated according to the energy harvesting principle. In this conjunction, it is very preferable to provide a capacitor. The advantage to doing so is that energy does not necessarily have to be provided via energy harvesting at the same time that the approaching hand of the user is detected. Rather, there can in any event be a certain chronological interval between the time that energy is generated via energy harvesting on the one hand and the time at which this energy is required by the proximity sensor on the other.

It is basically sufficient for the cover to be unlocked from the vessel via the control device based on the hand detected by the proximity sensor without this having to also be displayed as well. However, a preferred further development of the invention provides a response device, with which a response can be output about the locking status of the cover. This response device preferably involves a device that provides a visual and/or acoustic response. This type of response device is helpful in particular when unlocking only takes place after a predetermined period of time for which the hand must remain in a predetermined position, since as a rule the user will thus not wish to already remove the cover, even though unlocking has not happened yet.

In general, once the cover has been unlocked, it can remain so unchanged until the user actively decides to lock the cover with the vessel again, e.g., by pressing a button or twisting the cover placed on the vessel. However, a preferred further development of the invention provides that the control device be set up in such a way that, once a predetermined time has elapsed since removing the hand from the proximity sensor beyond the predetermined distance, the locking mechanism is actuated so as to again lock the cover. This makes it easier to handle the kitchen appliance, in particular in a case where the user changes his or her mind once the cover has been unlocked, e.g., because he or she wishes to further process foods contained in the kitchen appliance, since locking the cover requires nothing more than removing his or her hand.

The invention will be explained in more detail below with reference to the drawing based on preferred exemplary embodiments.

The drawing shows:

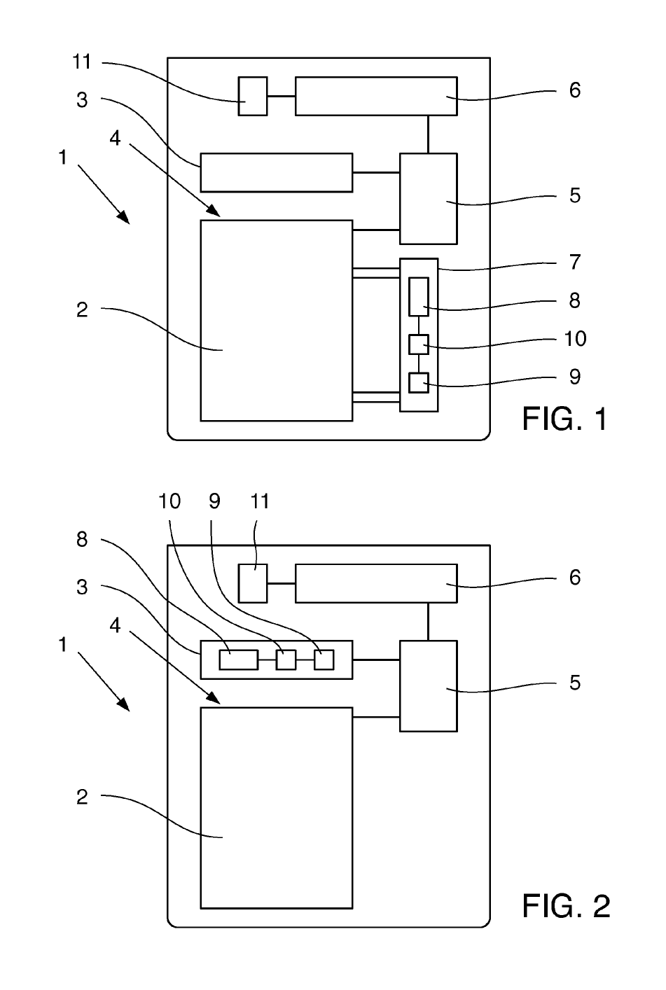

FIG. 1 a schematic view of a kitchen appliance according to a first preferred exemplary embodiment of the invention, in which a proximity sensor is provided in the handle, and

FIG. 2 a schematic view of a kitchen appliance according to a first preferred exemplary embodiment of the invention, in which a proximity sensor is provided in the cover.

Shown in the schematic view on FIG. 1 is a kitchen appliance 1 according to a preferred exemplary embodiment of the invention, which exhibits a vessel 2 along with a cover 3 for closing an opening 4 of the vessel 2. A locking mechanism 5 is provided so that the cover 3 can be reliably locked with the vessel 2, so that nothing can exit the vessel 2 in particular when processing foods inside of the vessel 2. The locking mechanism 5 is actuated by a control device 6, so that the cover 3 can be locked or unlocked on the vessel 2 in this way.

The vessel 2 of the kitchen appliance according to the preferred exemplary embodiment of the invention described here exhibits a handle 7, with which it can be removed from the remaining part of the kitchen appliance 1. This handle now incorporates a proximity sensor 8, which operates capacitively and is situated and set up in such a way that it can detect the presence of the hand of a user that grabs the handle 7.

Electric energy is supplied to the proximity sensor 8 via an energy supply system 9, which operates according to the energy harvesting principle. Specifically provided here as the energy supply system 9 is a photovoltaic device, which generates at least enough electrical energy from ambient light that the proximity sensor 8 can operate, and apart from capacitively detecting the hand of a user grabbing the handle 7, can also wirelessly communicate with the control device 6. To ensure a reliable operation of the kitchen appliance 1 given a partial shading of the photovoltaic device serving as the energy supply system 9, an intermediate energy store is interspersed between the proximity sensor 8 and energy supply system 9, specifically a capacitor.

If the hand of the user now grabs the handle 7 for a predetermined time, e.g., for longer than one second, the proximity sensor 8 detects that the hand has remained below a predetermined distance from the proximity sensor 8 for this predetermined time, and radios this information to the control device 6. The latter thereupon generates a control signal that it relays to the locking mechanism 5, so that the locking mechanism 5 unlocks the cover 3.

After unlocked, the cover 3 remains in this unlocked state for a predetermined time, here for five seconds, and can be taken off of the vessel 2 and removed by the user. If the cover 3 is not taken off of the vessel 2 within this predetermined period of time, the control device 6 actuates the locking mechanism 5 in such a way that the locking mechanism 5 again returns to the locked state.

A response device 11 is provided for indicating to the user that the cover 3 has been unlocked after his or her hand has touched the handle 7 for a long enough time. The latter provides the user with a response about the locked state of the cover 3 via an acoustic signal on the one hand and a visual display with different-colored LED's on the other. Therefore, if after the cover 3 is unlocked the user does not take off the cover within the period of five seconds available to him or her, the then resumed locked state of the cover 3 is again indicated to him or her acoustically by the response device 11 on the one hand, and on the other by the fact that the latter displays a red LED light once more, i.e., has switched from a green LED light to indicate the unlocked state back to the red LED light in the locked state.

Also shown schematically now on FIG. 2 is a kitchen appliance 1 according to a second preferred exemplary embodiment of the invention. The vessel 2 here exhibits no handle, and a proximity sensor 8 is provided in the cover 3, which here also serves to close the opening 4 of the vessel 2. The procedure here involves the user having to touch the cover 3 for a predetermined period, here also for one second, before the cover 3 is unlocked.

Here as well, unlocking takes place when the proximity sensor 8 detects that the hand has been placed on the cover 3 for at least the predetermined time of one second below the predetermined distance from the proximity sensor 8, so that the control device 6 correspondingly actuates the locking mechanism 5 for unlocking the cover 3. The proximity sensor 8 here also operates capacitively in this exemplary embodiment, and an energy supply system 9 that works based on the energy harvesting principle is provided too. Since such a kitchen appliance is generally always operated in light, the energy supply system used here is also a photovoltaic device, which is connected with the proximity sensor via an intermediate energy store 10, specifically a capacitor. Wireless signal transmission between the proximity sensor 8 and control device 6 along with the setup and function of the response device 11 correspond to the exemplary embodiment described with reference to FIG. 1.

As a consequence, indication is made overall to kitchen appliances 1 in which the respective cover 3 can be easily unlocked, specifically via manual actions of the user which the latter routinely performs anyway in advance of opening or removing the cover 3 from the vessel 2, namely holding the handle 7 of the kitchen appliance 1 according to the first preferred exemplary embodiment of the invention on the one hand, and on the other grabbing the cover 3 of the kitchen appliance according to the second preferred exemplary embodiment of the invention, so as to remove it from the vessel 2. As a result, the invention avoids additional manual actions for unlocking the cover 3 before the latter can be removed from the vessel 2.

Even if the exemplary embodiments according to FIG. 1 and FIG. 2 each only depict one proximity sensor in the handle 7 of the vessel 2 or in the cover 3 placed on the vessel 2, these exemplary embodiments can naturally also be combined, so that a respective proximity sensor 8 is provided in the cover 3 or in the handle 7.

### REFERENCE LIST

1 Kitchen appliance
2 Vessel
3 Cover
4 Opening
5 Locking mechanism
6 Control device
7 Handle
8 Proximity sensor
9 Energy supply system
10 Intermediate energy store
11 Response device

1. A kitchen appliance, with a vessel (2) and cover (3) for closing an opening (4) of the vessel (2), wherein a locking mechanism (5) with which the cover (3) can be locked to the vessel (2) and a control device (6) with which the locking state of the locking mechanism (5) can be controlled are provided, wherein a proximity sensor (8) is provided, which can be used to detect a physical approach by the hand of a user below a predetermined distance from the proximity sensor (8), and the proximity sensor (8) is connected with the control device (6) in such a way that the control device (6) can detect an approach by the hand of the user to a proximity sensor (8) below the predetermined distance, after which it can actuate the locking mechanism (5) in such a way that the latter unlocks the cover.

2. The kitchen appliance according to claim 1, wherein the vessel (2) exhibits a handle (7), and the proximity sensor (8) is situated inside of the handle (7).

3. The kitchen appliance according to claim 2, wherein the proximity sensor (8) inside of the handle (7) is spaced a distance apart from the surface of the handle (7), with the distance being less than the predetermined distance.

4. The kitchen appliance according to claim 1, wherein the proximity sensor (8) is situated in the cover (3).

5. The kitchen appliance according to claim 4, wherein the proximity sensor (8) inside of the cover (3) is spaced a distance apart from the surface of the cover (3), with the distance being less than the predetermined distance.

6. The kitchen appliance according to claim 1, wherein wireless signal transmission is provided between the proximity sensor (8) and control device (6).

7. The kitchen appliance according to claim 1, wherein the proximity sensor (8) exhibits an energy supply system (9), which generates energy based on the energy harvesting principle.

8. The kitchen appliance according to claim 7, wherein an intermediate energy store (10), preferably a capacitor, is provided for intermediately storing energy generated via the energy harvesting principle.

9. The kitchen appliance according to claim 1, wherein a response device (11) is provided, which can be used to output a response about the locked state of the cover (3), preferably in visual and/or acoustic form.

10. The kitchen appliance according to claim 1, wherein the control device (6) is set up in such a way that, once a predetermined time has elapsed since removing the hand from the proximity sensor (8) beyond the predetermined distance, the locking mechanism (5) is actuated so as to again lock the cover (3).
